(19) United States
(12) Patent Application Publication
(10) Pub. No.: US 2006/0083600 A1
(43) Pub. Date: Apr. 20, 2006

(54) Fastening apparatus and a special tool thereof

(76) Inventors: Yao Zhao, Jilin City (CN); Cheng Wang, Jilin City (CN); Xiumei Wang, Jilin City (CN)

Correspondence Address: DENNISON, SCHULTZ, DOUGHERTY & MACDONALD, 1727 KING STREET, SUITE 105, ALEXANDRIA, VA, 22314, US

(21) Appl. No.: 10/490,202

(22) PCT Filed: Sep. 28, 2001
(86) PCT No.: PCT/CN01/01463

§ 371 Date: Feb. 7, 2005

(51) Int. Cl. F16B 39/24

(52) U.S. Cl. 411/161

(57) ABSTRACT

An invention relates to metals or plastic means for fastening work-piece, especially to a stop backing, anti-detaching thread fastener and its matched specific tool. The invention provides thread fastener and washer, on opposite end faces of which are provided with stop backing teeth respectively, the stop backing teeth of one end face are elastic stop backing teeth. The thread fastener of the invention applies series structure engaged between teeth, such that the stop backing effect of thread fastener is reliable under various vibration environment and are convenient for quick attaching and detaching and may be used repeatedly. The anti-detaching series fastener cannot be detached in any way, once being fastened, it can be used in anti-detaching locations of various installations; it is simple for manufacturing, cost effective, effect reliable, and convenient for using.

### BACKGROUND OF THE INVENTION

1. Field of the Invention

The invention relates to metals or plastic means for fastening work piece, especially to a stop backing, anti-detaching thread fastener and its matched specific tool.

2. Background Technology

At present, the methods of stop backing of thread fastening means are: spring washer, threaded nut against each other, adhesive method, locking tab method, locking pin method, effective torque method, thread deformation method etc. The disadvantages of above various stop backing methods are non-ideal stop backing effect or inconvenient operation individually. Though there are types of anti-detaching fasteners, they have some disadvantages of being detachable by using other conventional tool respectively.

### SUMMARY OF THE INVENTION

In view of this, the intention of research and creation of the invention just is that how a type of structure can be provided which can implement stop backing or anti-detaching thread fastening structure, if it is a stop backing structure, it can be also detached conveniently by using matched specific tool, while for the anti-detaching structure there is absolutely not any effective method without damaging the structure to detach it.

By means of practical experiments of dealing for research, production, manufacturing and so on of various mechanical technology in many years, the applicant of the invention makes a completely new designing structure on the basis of researching and appraising, and the invention is made finally.

The object of the invention is to provide a new type of stop backing, anti-detaching thread fastening means which is convenient for using and has reliable stop backing effect, and the thread fastener can be used in all of anti-detaching fastening locations.

To achieve the above object the technical proposal of the invention is to be provided with complete set of thread fastener and washer, on opposite end faces of thread fastener and washer are provided with stop backing teeth respectively, the stop backing teeth of one of end faces are of elastic.

On both opposite end faces of thread fastener and washer of the invention are provided with stop backing teeth respectively which can engage with each other; the fasteners are bolt, thread strut, screw or nut; on outer circle of stop backing teeth of the supporting surface of screw, bolt or end face of nut are provided with radial circular concave conveniently detaching step; on the thread part of bolt, screw is provided with longitudinal positioning groove respectively; on the end face of washer stop backing teeth are arranged lifting up toward the direction of screwing, the diameter of end face provided with stop backing teeth of the washer is larger than the outer diameter of the fastener. Bolt, thread strut and washer are provided with positioning groove and positioning tooth engaged with each other; on the washer positioning teeth engaged with pre-formed positioning groove of fastened work piece is provided.

The stop backing series thread fastener is provided with matched inner hexagonal spanner, at each angle of which there is a bevel face rising gradually from lower part of angle apex to the left or right, the bevel face may fit with convenient detaching step provided above the supporting surface of bolt, thread strut or end face of nut respectively; the maximum distance between the bevel face and the opposite bevel face is large than or equal to the length of diagonal line of the inner hexagonal of spanner.

The anti-detaching series thread fastener includes bolt, screw, nut, characterized in that at outer edge of end face of the fastener there is supporting plane, on inner periphery stop backing teeth engaged with stop backing teeth of washer are arranged, the height of apex of the teeth is equal to or lower than supporting plane; on thread part of the bolt is provided with longitudinal positioning groove of the washer; on one side of washer is provided with stop backing teeth arranged around the hole diameter rising toward the direction of screwing, the diameter of end face provided with stop backing teeth of washer is smaller than the diameter of inner edge face of supporting surface of fastener respectively, on one side of the washer is provided with positioning tooth or in inner edge of it is provided with positioning tooth projected inward.

The advantage of the invention is that: to apply to the thread fastener series structure with teeth therebetween engaged structure, therefore, under various vibration environment, the stop backing effect of the fastener is reliable, its attaching and detaching work are simple and quick, and it can be used repeatedly; the anti-detaching series fastener cannot be detached in any way, once being fastened, it can be used in anti-detaching locations of various installations; it is simple for manufacturing, cost effective, effect reliable, and convenient for using.

### BRIEF DESCRIPTION OF THE DRAWINGS

FIG. 1 is an operation state scheme the first embodiment of stop backing series fastener of bolt type according to the present invention;

FIG. 2 is front view of washer in FIG. 1;

FIG. 3 is top view of FIG. 2;

FIG. 4 is section view along A-A line of FIG. 3;

FIG. 5 is front view of the nut in FIG. 1;

FIG. 6 is bottom view of FIG. 5;

FIG. 7 is an operation state scheme of the second embodiment of stop backing series fastener of screw type according to the present invention;

FIG. 8 is top view of fastened work piece in FIG. 7;

FIG. 9 is front view of washer in FIG. 7;

FIG. 10 is top view of FIG. 9;

FIG. 11 is section view along B-B line of FIG. 10;

FIG. 12 is front view of screw in FIG. 7;

FIG. 13 is bottom view of FIG. 12;

FIG. 14 is an operation state scheme of the third embodiment of anti-detaching series fastener of bolt type according to the present invention;

FIG. 15 is top view of nut in FIG. 14;

FIG. 16 is section view along C-C line of FIG. 15;

FIG. 17 is front view of washer in FIG. 14;

FIG. 18 is top view of FIG. 17;

FIG. 19 is section view along D-D line of FIG. 18;

FIG. 20 is an operation state scheme of the fourth embodiment of anti-detaching series fastener of screw type according to the present invention;

FIG. 21 is bottom view of screw in FIG. 20;

FIG. 22 is section view along E-E line of FIG. 21;

FIG. 23 is top view of washer in FIG. 20;

FIG. 24 is section view along F-F line of FIG. 23;

FIG. 25 is top view of specific conveniently detaching tool of stop backing series thread fasteners;

FIG. 26 is section view along G-G line of FIG. 25.

### DETAILED DESCRIPTION OF THE PREFERRED EMBODIMENT

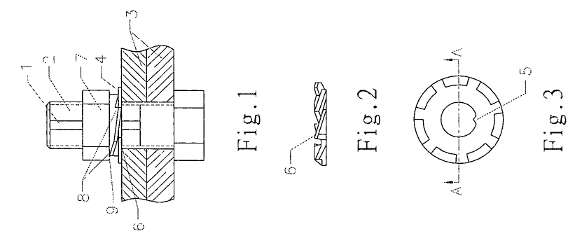

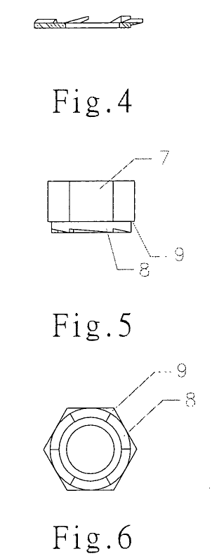

In the following, further descriptions of preferred embodiments will be given in reference to the accompanying drawings. A stop backing series fastener of bolt type of embodiment 1 as shown in FIGS. 1 to 6, comprising bolt 2 with longitudinal positioning groove 1 of washer passing through fastened work piece 3, projected inward positioning tooth 5 on inner edge of washer 4 aligned with positioning groove 1 is sheathed onto the part of bolt 2 exposing out of the work piece, the apex of stop backing teeth 6 arranged on outer edge of washer 4 rising towards the direction of screwing directs to thread end of the bolt 2, the diameter of the outer edge of the end face of washer 4 arranged with stop backing teeth is larger than the diameter of nut of fastener, the stop backing teeth 6 on washer 4 are elastic stop backing teeth, that is, the stop backing teeth can be pressed down under gravity, and can rebound after gravity disappeared. By screwing nut 7 in the thread of bolt 2 to cause the stop backing teeth 8 arranged on end face of the nut 7 to press work piece 3 and washer 4 tightly, and to cause one of stop backing teeth 6 on the washer 4 rebounds up along the gap between teeth of the stop backing teeth 8 of nut 7, that is, in stop backing state (as shown in FIG. 1), both stop backing teeth 8 of nut 7 and stop backing teeth 6 of washer 4 form a pawl structure.

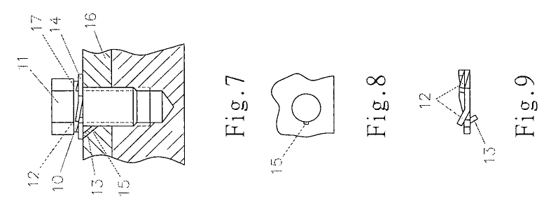

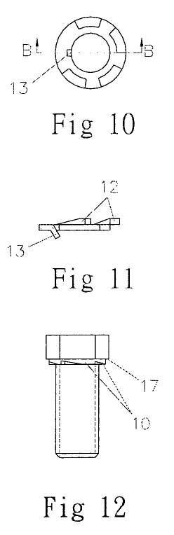

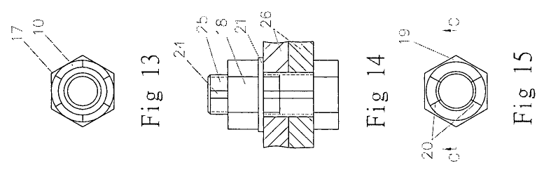

A stop backing series fastener of screw type of embodiment 2 as shown in FIGS. 7 to 13, it consists of screw 11 on the supporting surface 17 of which stop backing teeth 10 are arranged, on the outer edge of one side stop backing teeth 12 are arranged rising up toward the direction of screwing, on the other side there is washer 14 having positioning tooth 13 of work piece and fastened work piece 16 with pre-formed positioning groove 15 of washer. Its operation procedure is as follows: put washer 14 on work piece 16 and let its positioning tooth 13 align with positioning grove 15 of washer on work piece 16, as shown in FIG. 7. By screwing the screw 11, the stop backing teeth 10 press washer 14 and fastened work piece 16 tightly, one of the stop backing teeth 12 of the washer 14 rebounds up along the gap between the stop backing teeth 10 of supporting surface 17 of screw 11 head, thus presents a stop backing state (as shown in FIG. 7).

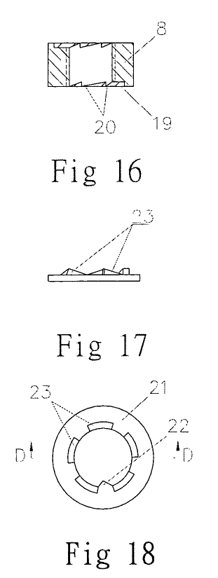

An anti-detaching series fastener of bolt type of embodiment 3 as shown in FIGS. 14 to 19, the main differences of the present embodiment and embodiment 1 are: supporting surface 19 is provided on outer edge of end face of the nut 18 and stop backing teeth 20 are arranged around inner edge of end face of the nut 18, the apex of teeth is lower than or equal to the height of supporting surface 19, such that the engaged part of stop backing teeth 20 of inner edge of end face of the nut 18 and stop backing teeth 23 of end face of the washer 21 surrounds the supporting surface 19 of outer edge of end face of the nut 18 and can not be detached. On inner edge of the washer 21 is provided with inward projected positioning tooth 22 and along periphery of hole diameter of washer 21 stop backing teeth 23 rising up toward the direction of screwing are arranged. The diameter of end face of the washer 21 having stop backing teeth 23 is less than the diameter of inner edge of supporting surface 19 of the nut 18. Its operation procedure is as follows: as shown in FIG. 14, a bolt 25 having longitudinal positioning groove 24 of washer is passed through fastened work piece 26, the inward projected positioning tooth 22 on inner edge of washer 21 are aligned with positioning groove 24 and sheathed on to the part of the bolt 25 exposed out of work piece 26, the apex of stop backing teeth 23 of washer 21 is directed toward the end part of thread, then the nut 18 is screwed onto the bolt 25 to press work piece 26 and washer 21 tightly to make all of the stop backing teeth 23 of washer 21 are rebounded along the gap between stop backing teeth 20 of the nut 18, that is, in an anti-detaching state (as shown in FIG. 14).

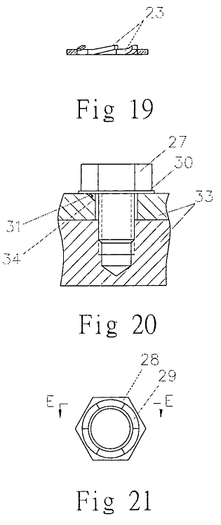

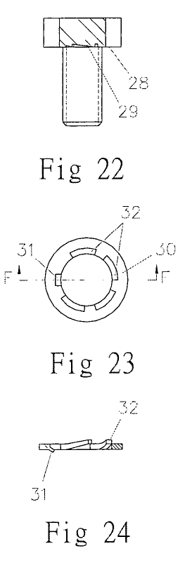

An anti-detaching series fastener of screw type of embodiment 4 as shown in FIGS. 20 to 24, the main differences between the present embodiment and embodiment 2 are: on outer edge of supporting surface of the screw 27 the supporting plane 28 is remained, the apex of stop backing teeth 29 arranged around bolt and the supporting plane are in the same height. On one side of washer 30 there is positioning tooth 31 of work piece, on the other side, the diameter of which is less than the diameter of inner edge of supporting surface 28 of the screw 27, and stop backing teeth 32 rising up toward the direction of screwing are arranged on periphery along hole diameter. Its operation procedure is as follows: the positioning tooth 31 of the washer 30 is aligned with pre-formed positioning groove 34 of work piece 33 and the washer 30 is placed on the work piece 33 and screwing the screw 27, pressing washer 30 and fastened work piece 33 tightly, all of stop backing teeth 32 of washer 30 are rebounded and engaged with stop backing teeth 29 of screw 27 head, that is in an anti-detaching state (as shown in FIG. 20).

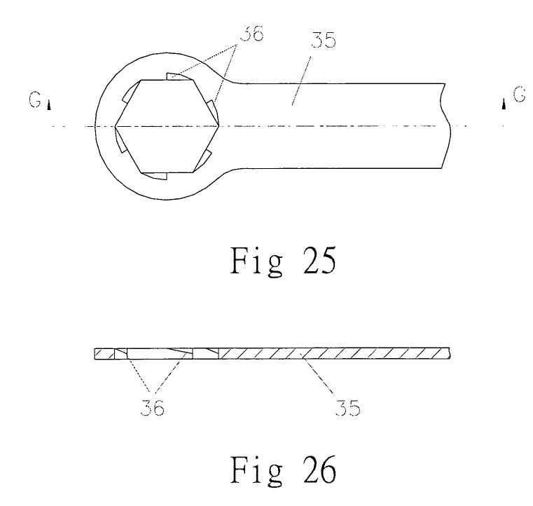

An embodiment 5 of conveniently detaching tool attached on stop backing series thread fasteners as shown in FIGS. 25, 26, and FIG. 1, the spanner 35 with one face of inclined faces 36 upward is sheathed on lower part of the nut 7 as shown in FIG. 1. By screwing in bevel down direction of inclined face 36, such that the inclined face 36 is acted on radial circular conveniently detaching step 9 projected inward of end face of the nut 7, and since the diameter of end face arranged stop backing teeth on outer edge of washer 4 is larger than the diameter of the nut 7 of fasteners, one side of plane of the spanner 35 presses down stop backing teeth 6 of the washer 4, then the nut 7 could be detached normally by using general tool.

The stop backing series, anti-detaching series thread fasteners provided by above embodiments may be matched and combined according to the specific requirements of fastened work piece and its environment.

To sum up, by using simple structural design, the stop backing, anti-detaching fastening means may be achieved in true sense by the invention. Significantly, the invention is a novel, advanced and having wide applications new design. The above description is specific embodiment and used technical principle of the invention, the equivalent modification and its function produced can be made without departing the spirit covered by the specifications and accompanying drawings, the scope of the invention is intended to be defined by the claims herein.

1. (canceled)

2. (canceled)

3. (canceled)

4. (canceled)

5. (canceled)

6. (canceled)

7. (canceled)

8. (canceled)

9. (canceled)

10. (canceled)

11. A thread fastening means, including a complete set of thread fastener and washer, characterized in that stop backing teeth are provided on opposite end faces of thread fastener and washer respectively, and the stop backing teeth on one end faces are elastic teeth, and that the fastener is a bolt, thread strut, screw or nut, and radial circular conveniently detaching concave step are provided on the outer edge of stop backing teeth of supporting surface of screw, bolt or end face of nut.

12. The thread fastening means as in claim 11, wherein said stop backing teeth are provided respectively on opposite end faces of thread fastener and washer and can be engaged with each other.

13. The thread fastening means as in claim 11, wherein said bolt, thread strut and washer are provided with positioning groove and positioning tooth that can engage with each other.

14. The thread fastening means as in claim 12, wherein said bolt, thread strut and washer are provided with positioning groove and positioning tooth that can engage with each other.

15. The thread fastening means as in claim 13, wherein said stop backing teeth rising up toward the direction of screwing are arranged on the end face of said washer, and the diameter of end face provided with stop backing teeth of said washer is lager than outer diameter of the fastener.

16. The thread fastening means as in claim 14, wherein said stop backing teeth rising up toward the direction of screwing are arranged on the end face of said washer, and the diameter of end face provided with stop backing teeth of said washer is lager than outer diameter of the fastener.

17. The thread fastening means as in claim 11, wherein said threaded fastener is provided with matched inner multi-angle spanner and at each angle there is an inclined face rising up gradually from lower part of angle apex to the left or right, and above stop backing teeth conveniently detaching step is provided on inclined face, end faces of both screw and bolt and end face of nut respectively.

18. The thread fastening means as in claim 12, wherein said threaded fastener is provided with matched inner multi-angle spanner and at each angle there is an inclined face rising up gradually from lower part of angle apex to the left or right, and above stop backing teeth conveniently detaching step is provided on inclined face, end faces of both screw and bolt and end face of nut respectively.

19. A thread fastening means, including a complete set of thread fastener and washer, characterized in that there is supporting surface on outer edge of end face of said fastener and stop backing teeth are arranged around inner edge of said fastener for being used to be engaged with stop backing teeth of said washer, and the stop backing teeth of one of end faces are elastic stop backing teeth, and that the apex of stop backing teeth and supporting surface are in the same height or less than the height of supporting structure.

20. The thread fastening means as in claim 19, wherein said stop backing teeth arranged around the hole diameter and rising up toward the direction of screwing are provided on one side of said washer, and the diameter of end face of the washer provided with stop backing teeth is less than the diameter of supporting surface and inner face of said fastener respectively.

21. The thread fastening means as in claim 11, wherein said washer is provided with positioning tooth on one side or on inner edge with inward projected positioning tooth.

22. The thread fastening means as in claim 12, wherein said washer is provided with positioning tooth on one side or on inner edge with inward projected positioning tooth.

23. The thread fastening means as in claim 19, wherein said washer is provided with positioning tooth on one side or on inner edge with inward projected positioning tooth.

24. The thread fastening means as in claim 20, wherein said washer is provided with positioning tooth on one side or on inner edge with inward projected positioning tooth.
